(19) United States
(12) Patent Application Publication
(10) Pub. No.: US 2013/0290926 A1
(43) Pub. Date: Oct. 31, 2013

(54) SEMANTIC CODE BINDING TO ENABLE NON-DEVELOPERS TO BUILD APPS

(71) Applicant: RHETI INC., Durham, NC (US)

(72) Inventor: Ralph Tavarez, Hallandale Beach, FL (US)

(73) Assignee: Rheti Inc., Durham, NC (US)

(21) Appl. No.: 13/874,043

(22) Filed: Apr. 30, 2013

Related U.S. Application Data
(60) Provisional application No. 61/640,259, filed on Apr. 30, 2012.

(51) Int. Cl. G06F 9/44

(52) U.S. Cl. CPC G06F 8/36
USPC 717/107

(57) ABSTRACT

In various embodiments, a computer-implemented method for ontology-based application construction is disclosed. The method comprises generating, by a processor, a first component comprising a first ontology, matching, by the processor, a first parameter of the first component with at least one second component comprising a second ontology; and linking, by the processor, the first parameter of the first component with a second parameter of the second component.

### CROSS-REFERENCE TO RELATED APPLICATIONS

This application claims the benefit under 35 U.S.C. §119(e) of U.S. Provisional Patent Application Ser. No. 61/640,259, entitled “SEMANTIC CODE BINDING TO ENABLE NON-DEVELOPERS TO BUILD APPS,” filed on Apr. 30, 2012.

### BACKGROUND

Software development is a challenging process, which is typically carried out by a skilled engineer to meet the needs of one or more end-users. One of the main challenges to that process is understanding and meeting the current requirements of the software. Requirements are often vague, in flux, and difficult to meet within a short time frame. One of the biggest challenges may stem from the engineer having to translate the user's need into code.

To help overcome these challenges the answer for many developers is code reuse. Code reuse is the use of existing software, or software knowledge, to build new software applications. Code reuse can, in theory, help reduce the development effort by allowing developers to focus on new requirements and avoid rebuilding solutions for common tasks. The more formal form of code reuse is an API (Application Programming Interface). An API is created with the deliberate intention of reuse. One challenge with API usage is knowledge transfer, as a user must have some knowledge on how to use any given API in order to implement the API. Knowledge transfer may be addressed via documentation or sample code. In many cases, a well-written API may dramatically reduce the effort of building software. However, even the best-written APIs require some understanding of programming. APIs therefore are not an adequate solution for addressing the disconnect between a developer and the needs of a user.

### SUMMARY

In various embodiments, a computer-implemented method for ontology-based application construction is disclosed. The method comprises generating, by a processor, a first component comprising a first ontology, matching, by the processor, a first parameter of the first component with at least one second component comprising a second ontology; and linking, by the processor, the first parameter of the first component with a second parameter of the second component.

In various embodiments, a computer-implemented method for generating an application component is disclosed. The method comprises: generating, by a processor, a first component comprising at least one function and at least one parameter; identifying, by the processor, one or more ontological terms associated with the first component; and generating, by the processor, an ontology for the first component, wherein the ontology identifies the at least one function and the at least one parameter of the first component.

In various embodiments, a computing device is disclosed. The computing device comprises a processor and a non-transitory computer-readable medium storing a computer program executable by the computer processor. When loaded by the processor, the computer program causes the processor to: construct a first component comprising a first ontology. The first ontology is configured to describe one or more features of the first component. The processor is further configured to match a first parameter of the first component with at least one second component comprising a second ontology configured to describe on or more features of the second component and link the first parameter of the first component with a second parameter of the second component.

### BRIEF DESCRIPTION OF THE FIGURES

FIG. 1 illustrates one embodiment of an ontology-based development environment for ontology-based construction of applications.

FIG. 2 illustrates one embodiment a process for publishing a complex object type.

FIG. 3 illustrates one embodiment of a process for publishing a global object.

FIG. 4 illustrates one embodiment of a process for publishing a feature.

FIG. 5 illustrates one embodiment of a process for binding one or more inputs of a component.

FIGS. 6-8 illustrates one embodiment of a user interface for selecting a binding for one or more inputs of a component.

FIG. 9 illustrates one embodiment of a process for binding one or more outputs of a component.

FIGS. 10-11 illustrates one embodiment of a user interface for selecting a binding for one or more outputs of a component.

FIG. 12 illustrates one embodiment of a process for parameter binding one or more features.

FIG. 13 illustrates one embodiment of a process for topic binding one or more features.

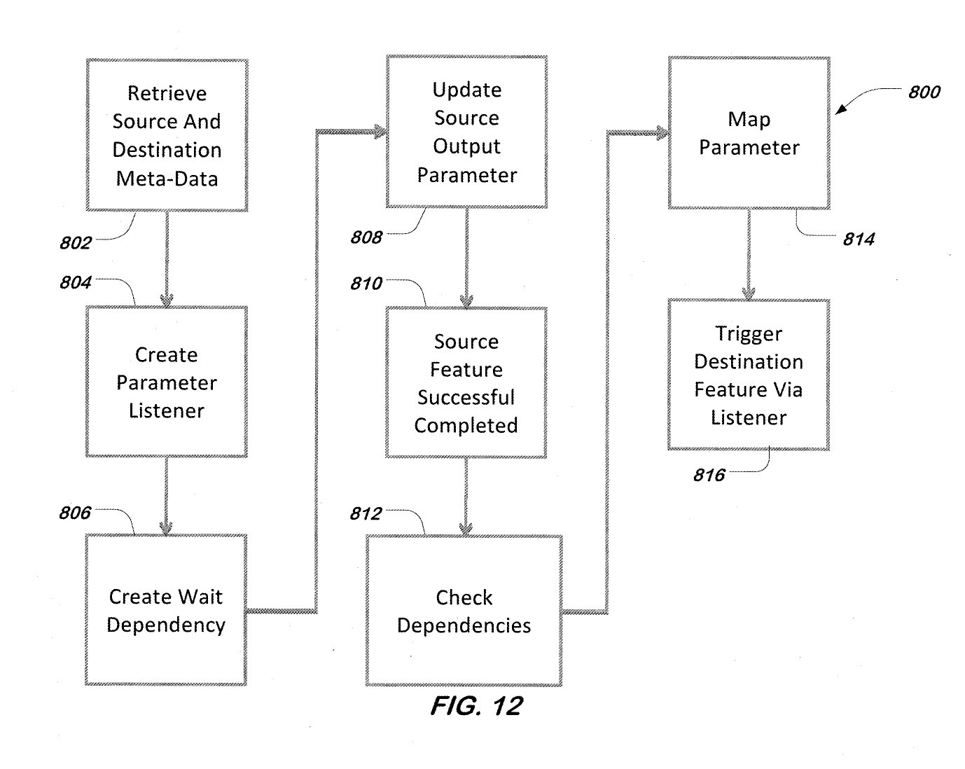

FIG. 14 illustrates one embodiment of a process for completion trigger binding one or more features.

FIG. 15 shows a schematic view of an illustrative electronic device.

FIG. 16 illustrates one embodiment of an input/output subsystem for an electronic device.

FIG. 17 illustrates embodiment of a communications interface for an electronic device.

FIG. 18 illustrates one embodiment of a memory subsystem for an electronic device.

### DESCRIPTION

In various embodiments, a computer-implemented method for ontology-based application construction is disclosed. The method comprises generating, by a processor, a first component comprising a first ontology, matching, by the processor, a first parameter of the first component with at least one second component comprising a second ontology; and linking, by the processor, the first parameter of the first component with a second parameter of the second component.

In various embodiments, a computer-implemented method for generating an application component is disclosed. The method comprises: generating, by a processor, a first component comprising at least one function and at least one parameter; identifying, by the processor, one or more ontological terms associated with the first component; and generating, by the processor, an ontology for the first component, wherein the ontology identifies the at least one function and the at least one parameter of the first component.

In various embodiments, a computing device is disclosed. The computing device comprises a processor and a non-transitory computer-readable medium storing a computer program executable by the computer processor. When loaded by the processor, the computer program causes the processor to: construct a first component comprising a first ontology. The first ontology is configured to describe one or more features of the first component. The processor is further configured to match a first parameter of the first component with at least one second component comprising a second ontology configured to describe on or more features of the second component and link the first parameter of the first component with a second parameter of the second component.

It is to be understood that this disclosure is not limited to particular aspects or embodiments described, and as such may vary. It is also to be understood that the terminology used herein is for the purpose of describing particular aspects or embodiments only, and is not intended to be limiting, since the scope of the method and system for ontology-based user generation of apps is defined only by the appended claims. A general overview of the various embodiments is provided in the description immediately following and particular implementation of the various embodiments is provided with reference to the figures. The overall scope of the present disclosure is provided on the appended claims.

In one general embodiment, semantic methodologies are used to facilitate a computer-implemented, component driven, touch based interface to enable a non-developer to build software applications (or apps). Semantic methodologies revolve around adding knowledge to documents via classified tags. Semantic tagging enhances traditional API documentation by enabling tools to infer component usage and compatibility based on the knowledge in the tag. In one embodiment, the classification of meta-data drives a touch-based interface that assists the non-programmer through the development process. Semantic tagging relies on building an ontology to formally represent knowledge as a set of concepts and the relationships between those concepts. The ontology renders shared vocabulary and taxonomy, which may be used to model a domain with the definition of objects and concepts, as well as their properties and relations. In one embodiment, the ontology may comprise classifications including, but not limited to, platforms, contributors, object types, features, and global objects. It will be appreciated by those skilled in the art that any or all of the classifications may be used. It will also be appreciated that any number of additional classifications may be included within the ontology.

In one embodiment, a rich programming knowledge vocabulary may be used to develop an ontology to enable simple construction of apps. For example, in one embodiment, the programming knowledge vocabulary may be based on a description logic-based ontology language, such as, for example, the Web Ontology Language (OWL). OWL is a World Wide Web Consortium (W3C) standard, developed to enhance web sites and builds on the Resource Description Framework (RDF) language, another W3C standard for data interchange. OWL enriches RDF by adding more vocabulary for describing properties and classes, such as, for example, relations between classes, disjointedness, cardinality, equality, richer typing of properties, characteristics of properties, and enumerated classes. RDF facilitates data merging even if the underlying schemas differ. API documentation tagging via OWL provides for a knowledge rich ontology that can be easily adapted. In other embodiments, the rich programming knowledge vocabulary may be developed in any suitable ontology programming language.

In one embodiment, to further simplify the development process, the APIs may be written as one or more black boxes. A black box is a software system or method that is viewed in terms of the inputs, outputs and transfer characteristics of the black box, without requiring any knowledge of the black box's internal workings or states. APIs that are properly tagged and written as a black box are referred to as features.

In one embodiment, the features may be stored on a remote cloud service and transferred to users on-demand. The on-demand nature of the catalog promotes reuse, as the latest versions of all APIs are immediately available. In some embodiments, features may be cached locally to enhance performance. In this embodiment, feature freshness may be coordinated by both a timestamp and version indicator.

In one embodiment, an integrated development environment (IDE) (the development environment) 2 provides a touch-based interface where a user can search for features to meet their needs. The search may be enhanced by the context of the current software development endeavor. For example, in one embodiment, platform details may be used to retrieve components designed to work in the given environment (such as iOS components when creating software for iOS, a mobile operating system used on mobile Apple products). As another example, components, which can lookup a phone number, may be retrieved to meet the requirement of a feature that sends an SMS.

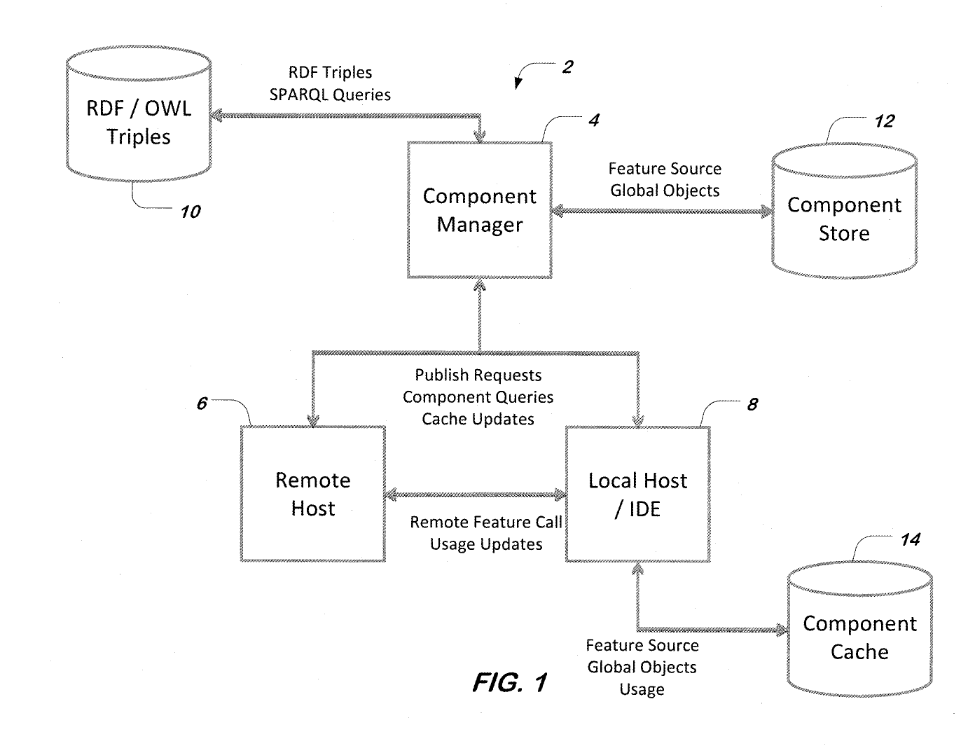

The ontology-based development environment 2 may comprise one or more services and one or more stores or caches. In the embodiment illustrated in FIG. 1, the ontology-based development environment 2 comprises a component manager 4, a remote host service 6, and a local host service 8. The illustrated embodiment further comprises an RDF store 10, a component store 12 and a local component store 14.

In one embodiment, the component manager 4 may publish and serve up components by managing access to both the RDF store 10 and the component store 12. The component manager 4 may act as a proxy to the RDF store 10 and physical storage (not shown) to hide the details of managing up time, load balancing and fault tolerance. The component manager 4 may, in one embodiment, receive requests via any suitable standardized remote API call, such as, for example, JSON or XML. In one embodiment, the component manager 4 may translate the request to SPARQL (SPARQL Protocol and RDF Query Language) queries. The responses from the component manager 4 may be any suitable standardized API response, such as, for example, a JSON or XML response. In one embodiment, the component manager 4 may respond in the same protocol used for the initial request. For example, if the initial API call is sent in JSON, the component manager 4 will respond with a JSON response. The component manager may provide an appropriate response based on the request, such as, for example, a JSON or XML response for list based inquiries or a binary or text object response for specific component retrieval requests.

In one embodiment, a host may be used by the ontology-based development environment 2. A host may be a distributed environment that fetches and prepares parameter values and global objects. The host may also orchestrate the code execution even if the component has been tagged to run on a remote environment. In one embodiment, the host may also manage wait states, including hydration and de-hydration of local variables.

In one embodiment, the ontology-based development environment 2 may comprise a remote host 6 and a local host 8. The remote host 6 manages remote API calls in the form of feature components for APIs that are tagged to execute on a server farm. For example, an API for a mobile app push notification may be executed by a remote host 6. The remote host 6 may manage the features, objects, and variables require by the remote APIs. In one embodiment, the remote host 6 may be in communication with the local host 8. In other embodiments, the remote host 6 may be in communication with the component manager 2. In one embodiment, the remote host may be located on a remote server (not shown) accessed via any suitable communications medium and protocol, such as, for example, a cloud server accessed via the internet.

In one embodiment, the ontology-based development environment 2 may comprise a local host 8. The local host 8 manages local API calls in the form of feature components. In some embodiments, the local host 8 may send an inquiry to the component manager 4 or a request to the remote host 6 in order to execute a local API. The local host 8 may manage the orchestration of features, local and global objects and the communication between the component manager 4 and remote host 6. In one embodiment, the orchestration may comprise dynamic scripting, caching or remote network calls.

In one embodiment, the ontology-based development environment 2 comprises an ontology for searching and identifying components. The ontology may comprise classifications such as, for example, platforms, contributors, object types, features, and global objects. In one embodiment, platforms may identify the technical requirement of a given component and may be stored as OWL classes. For example, a feature or global object may have a platform tag listed as “Android2.3” and “Java.” The ontology-based development environment 2 may intelligently filter out components for the given platform, such as, for example, returning only those components, which have a platform tag of “Android2.3.” In addition to filtering, the ontology-based development environment 2 may change its behavior based on a feature's platform tags. For example, in one embodiment, a component may have a platform tag of “JQueryMobile.” A “JQueryMobile” tag may indicate that JQuery Mobile libraries must be loaded into memory before the component may be used. The ontology-based development environment 2 may automatically load the JQuery Mobile libraries based on the platform tag to ensure proper operation of the component. In one embodiment, the platform tag may comprise a single property, such as, for example, the name of the platform on which the component may run. The platform name may be a unique camel case identifier of the platform.

In one embodiment, a contributor tag may identify individuals or organizations that interact with a given ontology. The contributor tag may be stored as OWL individuals. In one embodiment, as components are added to the ontology, the components may be automatically tagged with contributor information. The ontology-based development environment 2 may search the contributor information to find components during the build process and to control component access rights. In one embodiment, the contributor tag may comprise one or more properties, such as, for example, a universally unique identifier (UUID), which is assigned to each individual contributor to the ontology. The contributor tag may further comprise an identifier unique to each platform on which the component may be integrated, such as, for example, a Java package name style identifier. The contributor tag may further comprise a title of the contributor, which may be a user-friendly display name. In various embodiments, the title may comprise the first and last name of the contributor, the username of a contributor, or any other identifying information. The contributor tag may also comprise a description of the contributor. The description may include information such as, for example, education, years of experience, programming experience, or links (such as a HyperText Markup Language (HTML) link) to external information or sites.

In one embodiment, the ontology-based development tool 2 may comprise an object type ontology. Object type ontology may be used to classify one or more global objects and the inputs or outputs of one or more features stored in the component store 12. In one embodiment, object types may be either primitives or compound object types. Primitive object types may comprise universally defined OWL classes that represent traditional programming types such as, for example, strings, numbers or arrays. Compound object types may be contributor generated object types. The compound object types may infer special meaning to the contributor and may be stored as OWL individuals.

In one embodiment, the object type ontology may comprise a UUID assigned to the object by the platform. The object type ontology may further comprise a namespace identifier unique to the component within its given namespace. A namespace is a container for a set of identifiers (or names) and allows the disambiguation of homonym identifiers, which may reside in different namespaces. The namespace identifier may comprise a unique camel case style name assigned to the component within its relevant namespace. The object type ontology may further comprise a namespace reference to identify the namespace in which the component resides. The namespace reference may be any suitable identifier, such as, for example, a Java style sub-package name used to organize object types within the Java environment.

The object type ontology may further comprise a version identifier. The version identifier may track the number of updates or official builds of each object type that have been released. The version identifier may comprise a whole number or a decimal number. A common practice is list a version number in the format of X.YY in which the whole number, X, refers to major updates or build versions and the decimal portion of the number, .YY, refers to minor changes or updates. Those skilled in the art will recognize that any version numbering method may be employed. In one embodiment, the version number may be used by local copies of a component stored in the local cache 14 to ensure the latest version of the component is being used by the ontology-based development environment 2. In one embodiment, the version number may be automatically updated by the platform when the component is updated. In another embodiment, the version number may be manually set by the contributor updating the component.

In one embodiment, the object type ontology may comprise a title and a description. The title may be a user-friendly name describing the object type of the component. The description may include a detailed definition of the object type and may include a description of inputs, outputs, or functions of the component. The description may also include information regarding additional packages required for the component, such as, for example, common modules in the Java, Android, or iOS platforms. The object type ontology may further include one or more properties identifying who created the object type and when it was originally created. The object type ontology may comprise a date indicating when the object type was originally published on the platform. In one embodiment, the date is generated by the platform when the component is published to the platform. The object type ontology may further comprise contributor information indicating which contributors created or revised the component. The contributor property may include the UUID of the contributor who published the object type or the UUID of a contributor who edited the object type.

In one embodiment, the object type ontology may include one or more restrictions. The restrictions may comprise a list of contributors who have read or write access to the object type. In one embodiment, an empty list may imply that any user may read the object type (e.g., load and use the object type in a program) but that only the original contributor (as indicated by the contributor property) may modify or edit the object type. The object type ontology may further comprise platform information such as, for example, a list of platform technical requirements, if any, required to run the object. For example, an object type used for sending or receiving Short Message Service (SMS) messages may include a platform property indicating that the platform must be capable of sending and receiving SMS messages.

In one embodiment, the ontology-based development environment 2 may utilize one or more global objects. A global object is an instance of a given object type utilizing the actual data provided by the user. Global objects may be used as inputs to components and may be created as outputs of components. In one embodiment, global objects may be stored as OWL individuals comprising a global object ontology. The global object ontology may comprise a UUID. In one embodiment, the UUID may be assigned by the platform. The global object ontology may further comprise a namespace identifier unique to the global object within its given namespace and a namespace reference to identify the namespace associated with the global object.

In some embodiments, the global object ontology may further comprise a version tag to identify the current version of the global object or object type used by the system. The global object ontology may also include a title tag comprising a user-friendly name for the global object or object type, a description tag containing a detailed definition of the global object or object type, a date tag indicating the publishing date of the global object or object type of the global object, and a contributor tag identifying the UUID of the contributor who published or edited the global object or object type.

The global object ontology may further comprise one or more restrictions. In one embodiment, the one or more restrictions may comprise a list of contributors who can read or write the object type. An empty list may, in one embodiment, imply that any user can read the global object but only the original contributor can modify the global object. The global object ontology may also comprise a platform tag including a list of platform technical requirements, if any, required by the global object to execute on a given platform.

In one embodiment, the global object ontology may include an object type ontology. The object type ontology may identify the object type class or object type individual from which the global object is generated. For example, a global object may be an instance of an object type for addition. The object type ontology would identify the object type as an adder and classify the global object as an adder object. In one embodiment, the global object ontology may include a collection type tag. The collection type tag may identify the collection type of the object type and may be used to classify or group the global object.

As discussed above, the ontology-based development environment 2 may include one or more features. A feature is black-boxed API defined by a set of inputs, outputs and transfer characteristics. In one embodiment, a feature may include ontology for identifying the feature within the ontology-based development environment 2. The feature ontology may include one or more semantic identifiers for searching and identifying the features. In one embodiment, the feature ontology may include a UUID tag, a namespace identifier, and a namespace reference. The feature ontology may further comprise a version tag identifying the current version of the feature to allow version tracking of the feature in applications.

In one embodiment, the feature ontology may include a title comprising a user-friendly name, a description comprising a detailed definition of the feature, and a feature class indicating the OWL classification of the feature. The feature ontology may further comprise a date indicating the publication date of the feature, a contributor tag comprising the UUID of the contributor who published or revised the feature, and one or more restrictions. In one embodiment, the one or more restrictions may comprise a list of contributors who can read or write (modify) the object type. The feature ontology may further comprise a platform tag indicating the technical requirements of the platform for implementing the feature. For example, if a feature relates to sending or receiving SMS messages, the platform tag would indicate that the platform on which the feature is implemented must have the ability to send or receive SMS messages.

In one embodiment, the feature ontology may comprise one or more parameter identifiers. The one or more parameter identifiers may comprise a parameter ontology for identifying the characteristics of the one or more parameters. In one embodiment, the parameter ontology may include an identifier. The identifier may, for example, comprise a camel case style identifier that uniquely identifies the parameter within the associated feature. The parameter ontology may include a title comprising a user-friendly name for identifying the parameter, a topic comprising a topic name identifying the parameter as a specific event, and a description comprising a detailed explanation of the value required or contained within the parameter.

The parameter ontology may further comprise an input/output flag for identifying whether the parameter is an input requirement or an output result of the feature. For example, in one embodiment, an input/output flag may identify two parameters, X and Y, of an adder as inputs, indicating that the adder feature must be provided with both X and Y by another component in order to function correctly. The adder feature may also have a parameter, Sum, with an input/output flag-identifying Sum as an output result. The input/output flags ensure that the ontology-based development environment 2 connects the data streams from one feature to another to ensure proper inputs and outputs from the features.

In one embodiment, the parameter ontology may include an identifier indicating whether the parameter is a required parameter that must used in order for the feature to operate or an optional parameter that may be selectively used by the feature. The parameter ontology may further include an object type identifier to identify the object type of the parameter. For example, the object type property may identify a parameter as an array, a string, or a floating-point number. The parameter ontology may also comprise a collection type identifier. The collection type identifier may be used to classify the parameter within the platform, object, or instance.

In one embodiment, the ontology-based development environment 2 utilizes OWL. OWL is based on RDF and RDF facilitates data merging, allowing general updates, such as, for example platform updates or object type primitive updates, to be done via traditional forms of RDF processing such as SPARQL update/insert queries. Some types of classifications may require special processing and therefore have distinctive publishing processes. In one embodiment, classifications such as, for example compound object types, global objects and features require special publishing processes.

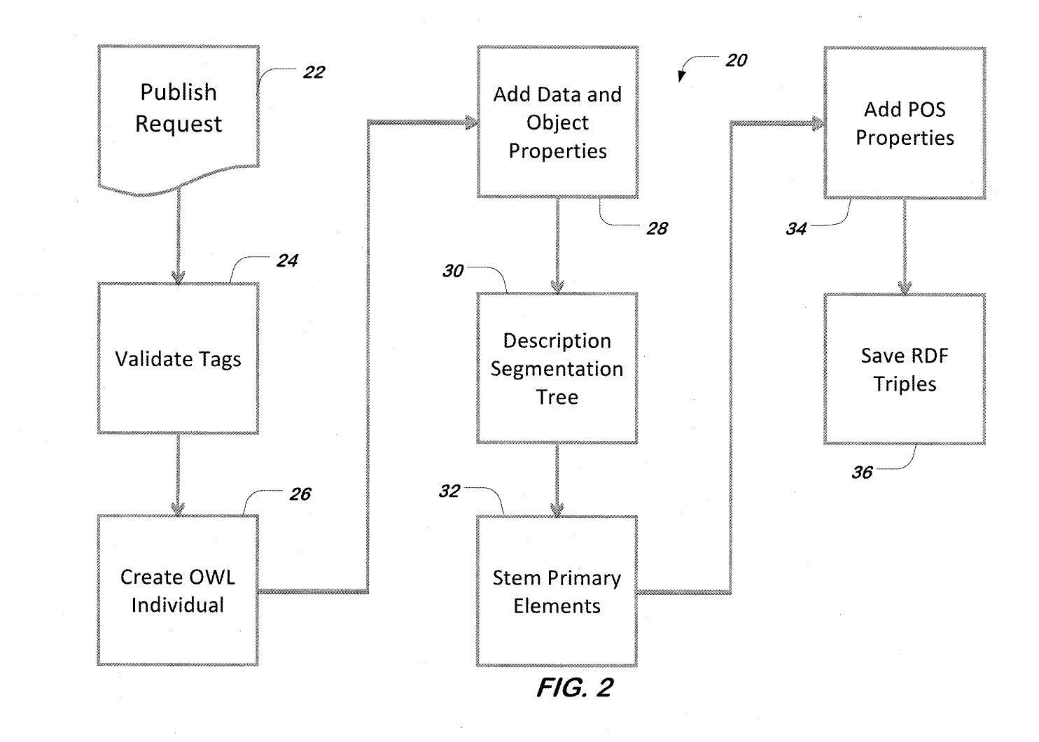

FIG. 2 illustrates one embodiment of a publishing process 20 for publishing an object type, such as, for example, a user-created compound object type. In the illustrated embodiment, a publication request is transmitted 22 to the component manager 4. The publication request may be transmitted 22 in any suitable programming language or data-interchange format, such as, for example, JSON or XML. The component manager 4 receives the publication request and validates 24 the meta-data of the object to be published based on the requirements specified by the ontology details of the ontology-based development environment 2. After verifying 24 the meta-data of the object to be published, the component manager 4 may create 26 an OWL object to represent the object type. Once the OWL object is created 26, the component manager 4 may add 28 the data-type and/or the object-type ontologies to the ontology of the individual OWL object.

In one embodiment, the object type description may be parsed 30 to identify the subject, object, and predicate of the description. The stem of the subject, object, and predicate are identified 32 and the stemmed parts of speech are added 34 to the ontology of the object type OWL individual. The three stemmed parts of speech, the subject, object, and predicate, may be referred to collectively as an RDF triple. The RDF triple may be saved 36 to the RDF store 10. Parsing 30, stemming 32, and storing 36 the RDF triple of the published object allows the ontology-based development environment 2 to easily search and identify published object types requested by a user.

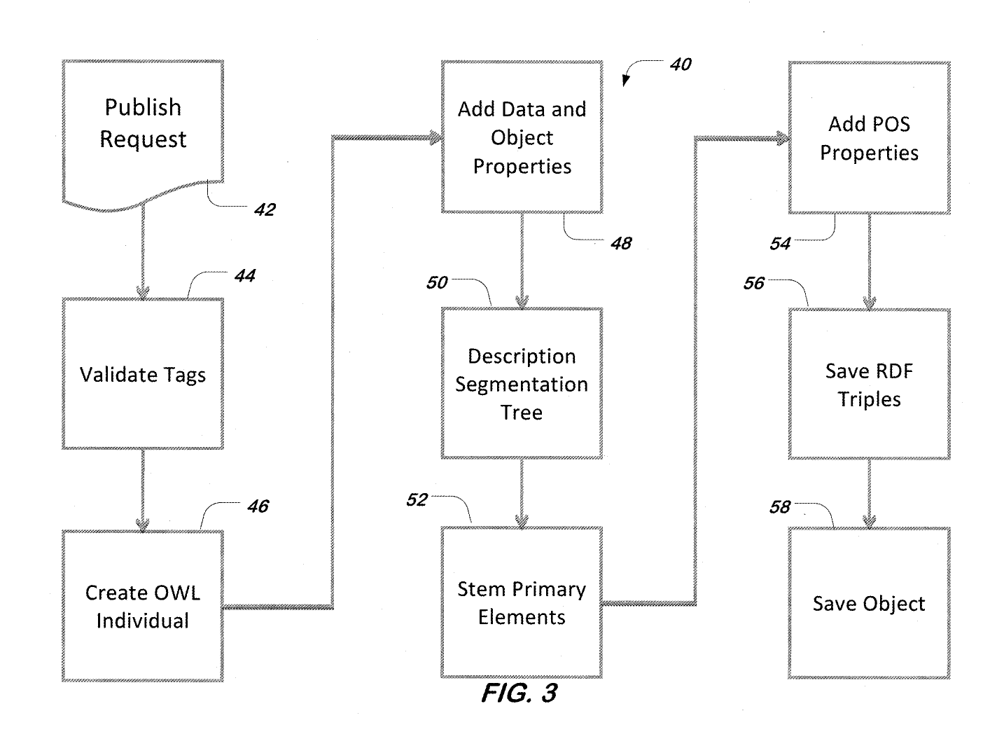

FIG. 3 illustrates one embodiment of a publishing process 40 for publishing a global object. The steps for publishing a global object shown in FIG. 3 are similar to the steps for publishing an object type described with reference to FIG. 2, with the global object having one or more different properties defined in the ontology of the ontology-based development environment 2. In one embodiment, global objects may be saved as serialized objects, text streams or binary files.

In the illustrated embodiment, a publication request is transmitted 42 to the component manager 4. The publication request may be transmitted 42 in any suitable programming language or data-interchange format, such as, for example, JSON or XML. The component manager 4 receives the publication request and validates 44 the meta-data of the object to be published based on the requirements specified by the ontology details of the ontology-based development environment 2. After verifying 44 the meta-data of the object to be published, the component manager 4 may create 46 an OWL individual to represent the global object. Once the owl individual is created 46, the component manager 4 may add 48 the data-type and the object-type ontology to the global object ontology.

In one embodiment, the global object description may be parsed 50 to identify the subject, object, and predicate of the description. The stem of the subject, object, and predicate are identified and the stemmed parts of speech are added to the ontology of the OWL individual. In one embodiment, the global object may comprise data that is serialized and stored 58 in the component store 12. In one embodiment, the global object data may be stored 58 as serialized objects, text streams, or binary files.

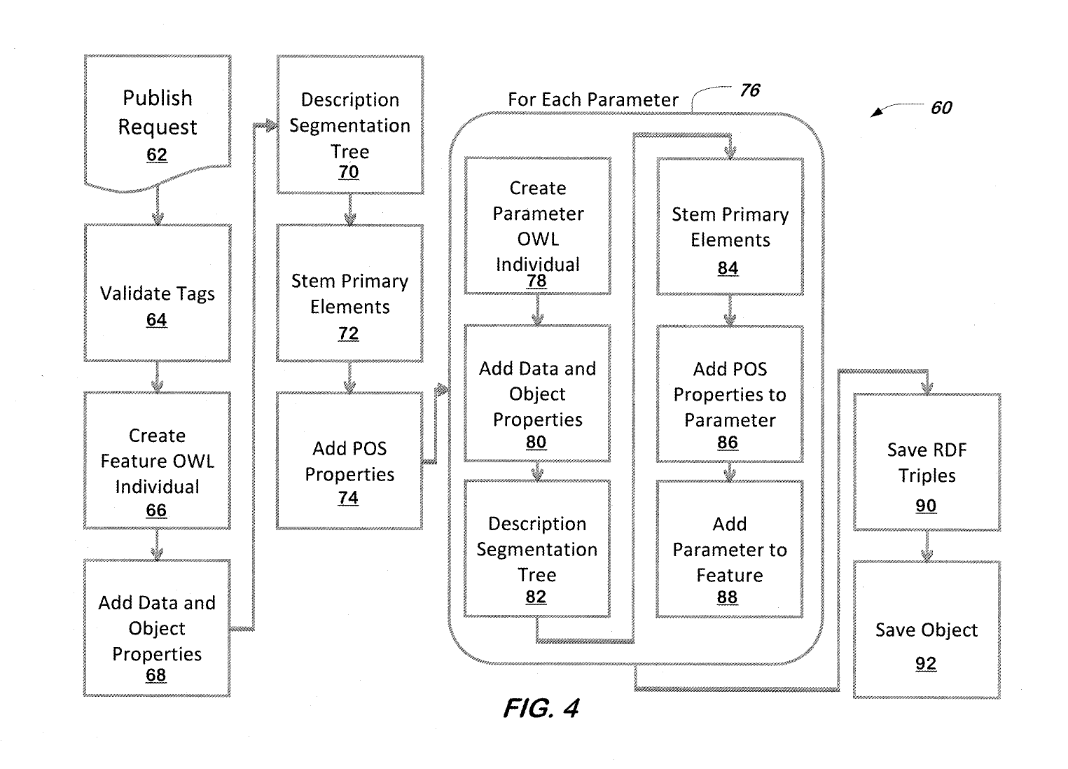

FIG. 4 illustrates one embodiment of a publishing process 60 for publishing one or more features. The publishing process 60 for publishing features is similar to the publishing process 20, 40 for object types and global objects, but requires the processing of each parameter of the feature during publication. In one embodiment, the actual code of a feature is stored in the component store. Feature code may be stored as binary objects such as, for example, jar files for Java or as text files for scripting languages such as, for example, JavaScript.

In the illustrated embodiment, a publication request is transmitted 62 to the component manager 4. The publication request may be transmitted 62 in any suitable programming language or data-interchange format, such as, for example, JSON or XML. The component manager 4 receives the publication request and validates 64 the meta-data of the object to be published based on the requirements specified by the ontology details of the ontology-based development environment 2. After verifying 64 the meta-data of the object to be published, the component manager 4 may create 66 an OWL individual to represent the global object. Once the OWL individual is created 66, the component manager 4 may add 68 the data-type and the object-type ontology to the feature ontology. In one embodiment, the feature description may be parsed 70 to identify the subject, object, and predicate of the description. The stem of the subject, object, and predicate are identified 72 and the stemmed parts of speech are added 74 to the ontology of the OWL individual.

Publishing a feature may require processing 76 of each parameter included within the feature. For each parameter, an OWL individual is created 78 to represent the parameter within the ontology-based development environment 2. The OWL data-type and object-type ontology may be added 80 to the OWL individual of the parameter. The description of the parameter is parsed 82 into a sentence segmentation tree to identify the subject, object, and predicate of the parameter description. Once identified, the parts of speech are stemmed 84 and added 86 to the ontology of the OWL individual for the parameter. Once the parameter OWL individual has been built by the component manager 4, the parameter OWL individual is added 88 to the feature OWL individual. The component manager 4 will repeat the parameter processing 76 for each parameter contained within the feature.

In one embodiment, the feature processing 60 may comprise saving 90 the RDF triples of the feature and the parameters to the RDF store 10. The feature may then be serialized and saved 92 to the component store 12 of the ontology-based development environment 2. The feature may be stored as binary objects such as, for example, jar files for Java or as text files for scripting languages such as, for example, JavaScript.

With a robust catalog of properly tagged and published features (black-box APIs), the ontology-based development environment 2 can be used to assist the user to use, configure and combine features. The ontology-based development environment 2 may comprise a recommendation engine that understands feature requirements and feature results. In one embodiment, the ontology-based development environment 2 may suggest and bind inputs, outputs, events and feature dependencies to build and implement a user-created app.

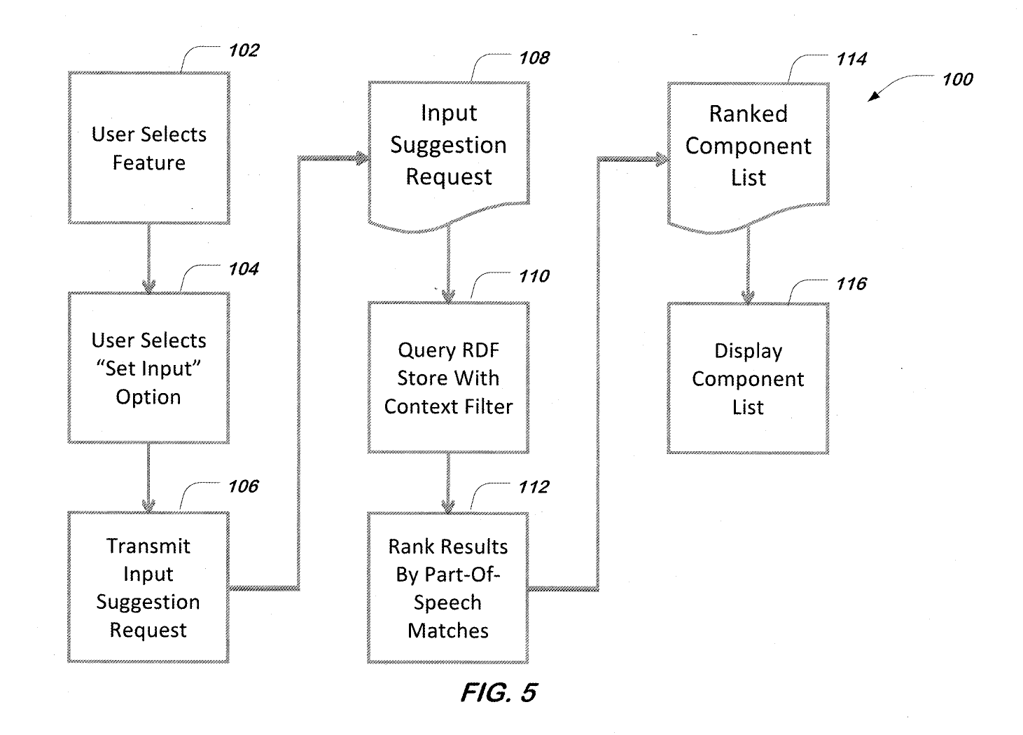

In one embodiment, the ontology-based development environment 2 may suggest input binding options to a user when the user selects a first feature having one or more inputs. FIG. 5 illustrates one embodiment of a process for suggesting input binding options 100 to a user by the ontology-based development environment 2. In one embodiment, the process for suggesting input binding 100 may be directed towards finding one or more features or global objects that can meet the input requirement of the first feature. In the illustrated embodiment, a user may use the IDE of the ontology-based development environment 2 to select 102 a first feature for use in a user-built app. The first feature may comprise one or more unbound inputs. Once a user has selected a first feature, the ontology-based development environment 2 may prompt 104 the user with a menu of the available options for each input of the first feature. For each of the unbound inputs of the first feature, an input suggestion request may be sent 106 to the component manager 4. The input suggestion request may comprise current context information relating to the app being built by the user. The current context information may comprise, for example, platform information, destination feature information, current features and bindings included in the app, current objects and bindings of those objects, and the current contributor(s) to the app. The input suggestion request may, in one embodiment, contain all of the current context information. In another embodiment, the input suggestion request may comprise a subset of the current context information.

In one embodiment, the component manager 4 may use the current context information received 108 in the input suggestion request to create 110 a search for components that meet the input requirements of the first feature. The component manager 4 may generate 110 the search in any suitable language, such as, for example, a SPARQL query. For example, the component manager 4 may construct a SPARQL query comprising a Find command. The find command may be instructed to find a component within the component store. The SPARQL query may be based on one or more search requirements supplied by the input suggestion request.

In one embodiment, the SPARQL query may comprise one or more search parameters. The one or more search parameters may be based on one or more ontology terms supplied by the input suggestion request. For example, in one embodiment, an input search request may provide an ontology term comprising the subject “feature.” The component manager 4 may then construct a query to find a second feature within the component store. The input suggestion request may further comprise one or more predicate and object pairs to further limit the search by the component manager 4. For example, in one embodiment, a request to find a “feature” may include a predicate and object pair of “hasOutputof” and “PhoneNumber.” The search query constructed by the component manager 4 will find all of the features within the component store which have an output identified by the ontology of the feature as a phone number. One example of a SPARQL query comprising multiple predicate-object pairs is shown below:
Find “feature” (subject) that
“hasOutputOf” (predicate):“PhoneNumber” (object),
“hasContributorOf” (predicate):“Rheti” (object),
“platformOf” (predicate):“Android” (object),
“describedBy” (predicate):“verb-send” (object),
“describedBy” (predicate):“noun-SMS” (object).
   The above search query will return any features in the component store 12 which have an output identified as a phone number, a contributor named Rheti, is compatible with the Android operating system, and which include the verb “send” and the noun “SMS” within the description of the feature, e.g., the description states that the feature may be used to “send an SMS.”

In one embodiment, the component manager 4 may generate a list of one or more components which meet the search requirements provided by the input suggestion request. The component manager 4 may generate 114 a ranked component list. The ranked component list may be generated 114 based on how well the parts-of-speech of the retrieved components match the parts-of-speech provided by the input suggestion request. The ranked component list may be displayed 116 to the user to allow the user to select one of the identified components. After a user has selected a returned component, the input of the first feature may be bound to the returned component. Binding the input may comprise, for example, tying an output of the returned component to the input of the first feature or setting the value of the input of the first feature to a value of the returned component.

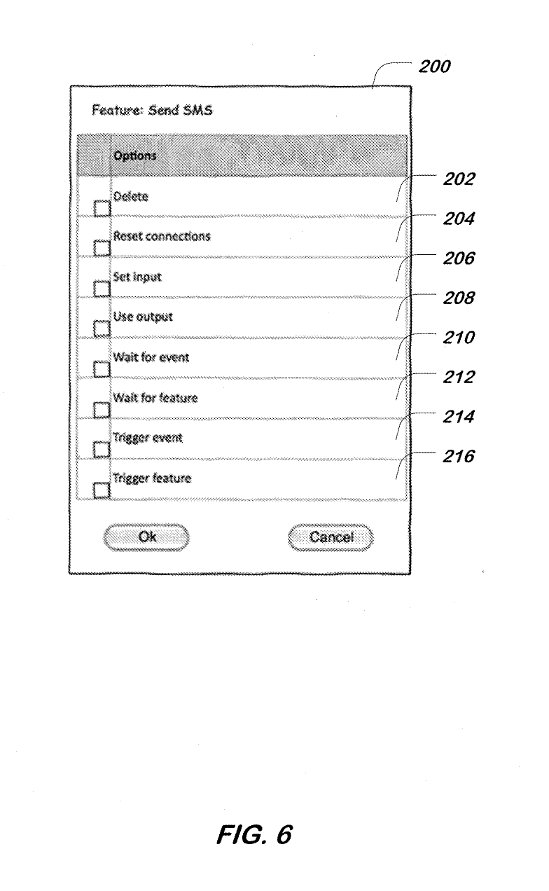

FIGS. 6-8 show one embodiment of the IDE of the ontology-based development environment 2. The illustrated figures show one possible embodiment of the process for identifying and requesting input suggestions by the user. FIG. 6 shows one embodiment of a feature selection screen 200 a user may encounter after selecting a first feature. In the illustrated embodiment, the selected feature is titled “Send SMS” and enables a user-built app to send a SMS message. As can be seen in FIG. 6, selecting the Send SMS feature may cause the ontology-based development environment 2 to display various options for the selected feature to the user. In the illustrated embodiment, the user may choose to delete 202 the selected feature from the program, reset 204 the input/output bindings of the selected feature, set 206 the inputs of the feature, select 208 outputs to be used by the feature. The user may further select one or more behaviors for the selected feature, such as, for example, waiting 210 for an event to occur before activating the feature, waiting 212 for a second feature to execute before executing the feature, triggering an event when the feature executes, or triggering a second feature when the feature executes. Those skilled in the art will recognize that any suitable option may be provided to the user for selection and editing and are within the scope of this disclosure.

FIG. 7 illustrates one embodiment of an input selection screen 300 which may displayed to a user after the user has selected the set input feature 206 from the feature selection screen 200. The input selection screen 300 shows a currently selected input 302. The currently selected input 302 may be changed to allow a user to set each of the inputs for a selected feature. In the illustrated embodiment, the currently selected input 302 is a phone number input for the Send SMS feature. After selecting a currently selected input 302, the user is provided with one or more source options 304-308 for the input value. As can be seen in FIG. 7, a user may set the phone number input to a constant value 304, instruct the app to ask for the value later 306, or to use a feature or object 308 from the component store to set the value. If a user selects the use a feature or object option 308, a component selection screen 400 (shown in FIG. 8) will be displayed to the user to allow the user to select the feature or object to be bound to the input.

FIG. 8 illustrates one embodiment of a component selection screen 400. The component selection screen 400 may be displayed to a user if a user chooses to use a feature or object as source for an input. In the illustrated embodiment, the component manager 4 has performed a query for components which meet the requirements provided by the input suggestion request (see FIG. 5). The ontology-based development environment 2 displays a ranked list 402 of the components, which were returned by the component manager 4, based on the provided ontology. The component manager 4 identified four possible components, which may be bound to the phone number input of the Send SMS feature. The user may select any of the identified components to bind to the phone number input of the Send SMS feature. Once selected, the ontology-based development environment 2 may automatically bind the current input of the feature with the correct value or output of the selected component.

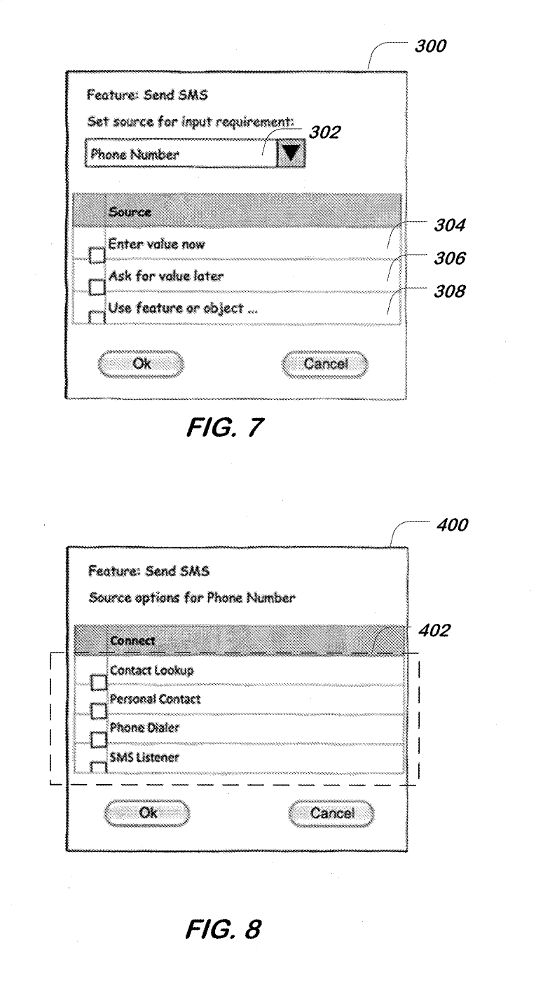

In one embodiment, the ontology-based development environment 2 may provide one or more suggestions for binding the output of a first component to a second component. FIG. 9 illustrates one embodiment of a process for binding an output 500 of a first component to a second component. In one embodiment, the process for binding an output 500 may be directed towards finding one or more components that can utilize the output of the first component. In the illustrated embodiment, a user may use the IDE of the ontology-based development environment 2 to select 502 a first feature for use in a user-built app. The first feature may comprise one or more unbound outputs. Once a user has selected a first feature, the ontology-based development environment 2 may prompt 504 the user with a menu of the available options for each output of the first feature. For each of the unbound outputs of the first feature, an output suggestion request may be sent 506 to the component manager 4. The output suggestion request may comprise current context information relating to the app being built by the user. The current context information may comprise, for example, platform information, destination feature information, current features and bindings included in the app, current objects and bindings of those objects, and the current contributor(s) to the app. The output suggestion request may, in one embodiment, contain all of the current context information. In another embodiment, the output suggestion request may comprise a subset of the current context information.

In one embodiment, the component manager 4 may use the current context information received 508 in the output suggestion request to create 510 a search for components that meet the input requirements of the first feature. The component manager 4 may generate 510 the search in any suitable language, such as, for example, a SPARQL query. For example, the component manager 4 may construct a SPARQL query comprising a Find command. The find command may be instructed to find a component within the component store. The SPARQL query may be based on one or more search requirements supplied by the output suggestion request.

In one embodiment, the SPARQL query may comprise one or more search parameters. The one or more search parameters may be based on one or more ontology terms supplied by the output suggestion request. For example, in one embodiment, an output search request may provide an ontology term comprising the subject “feature.” The component manager 4 may then construct a query to find a second feature within the component store. The output suggestion request may further comprise one or more predicate and object pairs to further limit the search by the component manager 4. For example, in one embodiment, a request to find a “feature” may include a predicate and object pair of “hasInputof” and “Message.” The search query constructed by the component manager 4 will find all of the features within the component store which have an input identified by the ontology of the feature as a message. One example of a SPARQL query comprising multiple predicate-object pairs is shown below:
Find “feature” (subject) that
“hasIntputOf” (predicate):“Message” (object),
“hasContributorOf” (predicate):“Rheti” (object),
“platformOf” (predicate):“Android” (object),
“describedBy” (predicate):“verb-listen” (object),
“describedBy” (predicate):“noun-SMS” (object).
   The above search query will return any features in the component store 12 which have an input identified as a message, a contributor named Rheti, is compatible with the Android operating system, and which include the verb “listen” and the noun “SMS” within the description of the feature, e.g., the description states that the feature may be used to “listen for an SMS.”

In one embodiment, the component manager 4 may generate 512 a list of one or more components which meet the search requirements provided by the output suggestion request. The component manager 4 may generate 514 a ranked component list. The ranked component list may be generated 514 based on how well the parts-of-speech of the retrieved components match the parts-of-speech provided by the output suggestion request. The ranked component list may be displayed 516 to the user to allow the user to select one of the identified components. After a user has selected a returned component, the output of the first feature is bound to the returned component. This binding may comprise, for example, tying an input of the returned component to the output of the first feature.

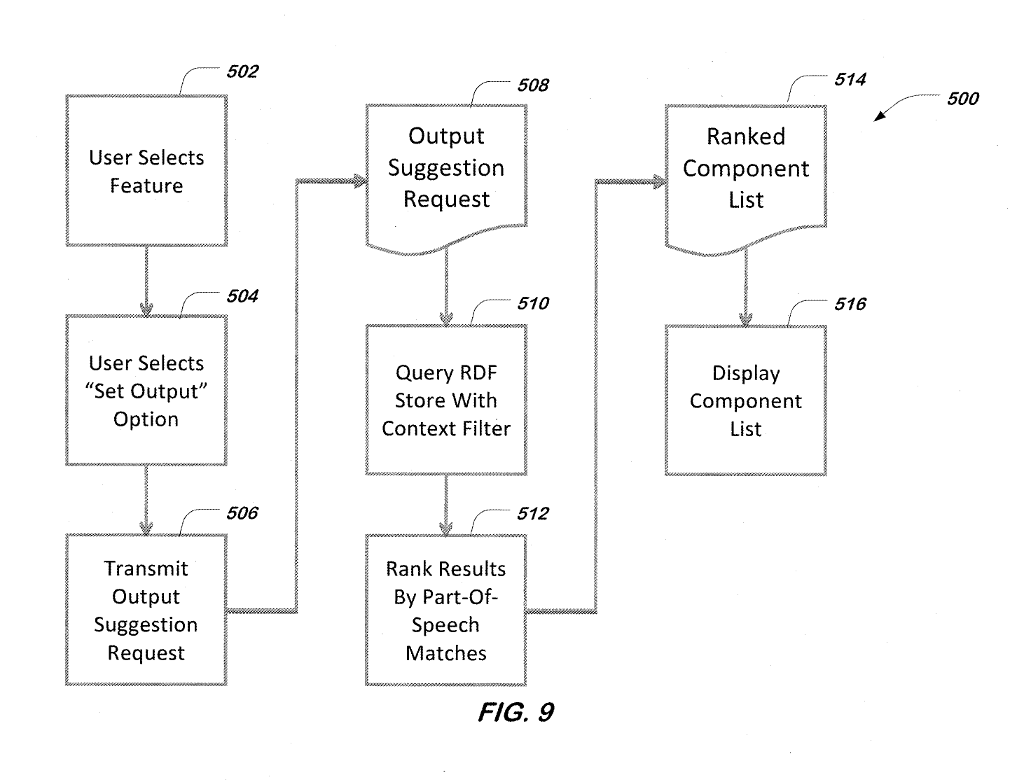

FIGS. 6 and 10-11 show one embodiment of the IDE of the ontology-based development environment 2. The illustrated figures show one possible embodiment of the process for identifying and requesting output suggestions by the user. Referring back to FIG. 6, which illustrates one embodiment of a feature selection screen 200, a user may select the use output option 208. After selecting the use output option, a user may be presented with an output selection screen 600. One embodiment of the output selection screen 600 is shown in FIG. 10. The output selection screen 600 may comprise a currently selected output 602. In the illustrated embodiment, the “Message” output of the SMS Listener has been selected. After selecting a currently selected output 602, the user is presented with one or more output destinations 604-608 for binding the currently selected output 602. The “Message” output of the SMS Listener may be left unbound by selecting the None option 604, may be output as a global variable 606, or may be used as an input for another feature 608.

In one embodiment, a user who chooses to use the output of the current feature as an input for another feature may be presented with the feature selection screen 700, shown in FIG. 11. The feature selection screen 700 may display one or more features 702 that are capable of using the currently selected output 602 as an input. The one or more features 702 may be identified by the component manager 4 through a SPARQL query of the component store (see FIG. 9).

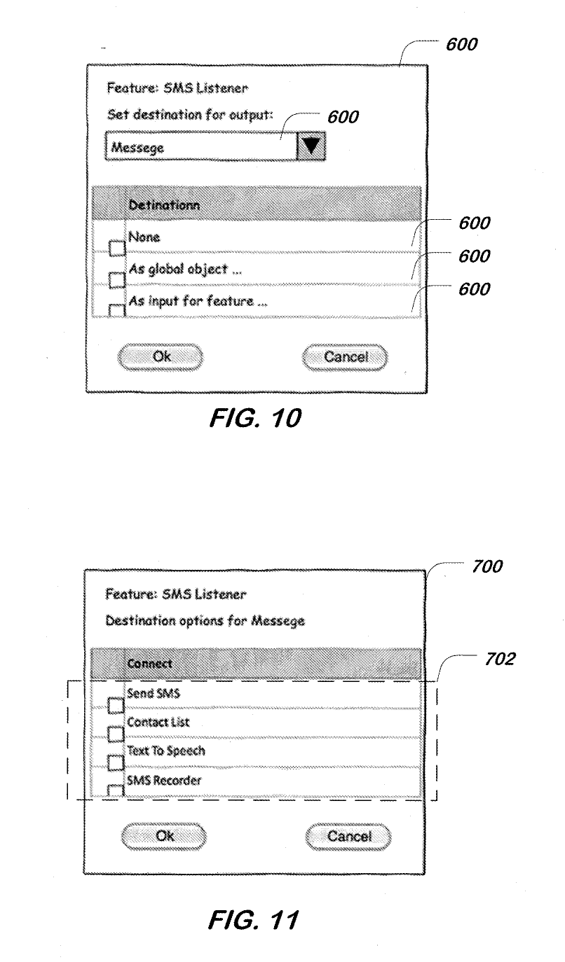

In one embodiment, once the user has decided to bind the output of one component to the input of another component, the ontology-based development environment 2 may generate source code to bind the two components together. In one embodiment, the source code generated may comprise a wait state for the destination component based on the receipt of a source parameter value. FIG. 12 illustrates one embodiment of a process for generating the source code to create a wait state for the bound features based on a parameter value. In the illustrated embodiment, the ontology meta-data for both the source feature and the destination feature may be retrieved by the component manager 4. The meta-data may be retrieved from the local store 12 or the remote store 14. Once the meta-data has been retrieved, a parameter callback may be created 804. In one embodiment, the parameter callback may be triggered when the parameter is generated by the output feature. A wait dependency may be created 806 for the destination feature. The wait dependency sets a behavior for the destination feature, which causes the destination feature to remain inactive until the selected parameter is generated and delivered to the destination feature.

In one embodiment, the source feature may generate 808 the output parameter during operation. Once the source feature has created 808 the parameter, the source feature notifies 810 the respective host, either the remote host 6 or the local host 8, that the parameter has been generated. After being notified that the parameter has been created, the host may verify 812 the dependencies of the destination feature to ensure that the all dependencies of the destination feature have been fulfilled. For example, a destination feature may have dependencies from a first source feature and a second source feature. The host ensures that the parameters required from both the first and second source features have been generated before executing the destination feature.

In one embodiment, after the host has verified that all dependencies are satisfied, the host may map 814 the source parameter names to the destination parameter names to ensure proper transfer of data from the source parameter to the destination parameter. After mapping each of the source parameters, the host may trigger 816 the callback of the destination feature, which causes the destination feature to execute, using the supplied source parameters.

In one embodiment, the source feature and the destination feature may be topically bound. Topic binding is similar to parameter binding, but instead of waiting for a parameter value, features bound by topic wait for an event to occur. In one embodiment, the topic bindings may be conditional and are not required to execute. Unlike parameters, which must be provided when a source feature has completed execution, a topic event may not be triggered by the source feature. FIG. 12 illustrates one embodiment of a process for topic binding of a destination feature.

In one embodiment, the process for topic binding of a destination feature may comprise retrieving 902 the ontology meta-data for both the source and destination feature from the component store 12 or the local cache 14. A topic call back may be created 904 by the ontology-based development environment 2, which activates the destination feature when a triggering event occurs. The ontology-based development environment 2 may generate 906 a wait dependency based on the triggering event. The wait dependency sets a behavior for the destination feature, which causes the destination feature to remain inactive until the triggering event is triggered by the source feature.

In one embodiment, the source feature may trigger 908 the triggering event. The source feature may notify 910 a host, either the remote host 6 or the local host 8, that the triggering event has occurred. After being notified 910 that the triggering event has occurred, the host may verify 912 the dependencies of the destination feature. In some embodiments, the destination feature may have one or more topic bindings and be dependent one or more triggering events. In another embodiment, the destination may have both parameter bindings and topic bindings. Once the host has verified 912 that all dependencies of the destination feature have been satisfied, the host may trigger 914 the topic callback to notify the destination feature that the triggering event has occurred, causing the destination feature to execute.

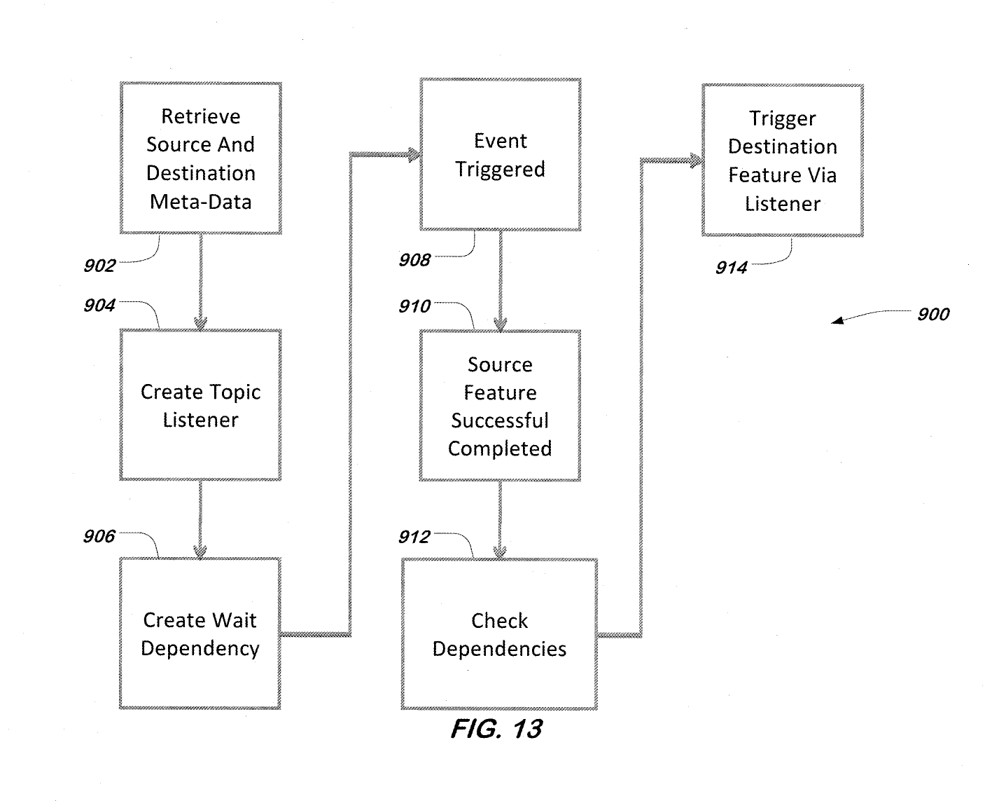

FIG. 14 illustrates one embodiment of a completion triggering binding 1000. Completion trigger binding is similar to parameter binding without the parameter exchange. In one embodiment, event triggers and parameters are not required for completion trigger binding. In another embodiment, completion of the triggering event or generation of the triggering parameter may be required. In one embodiment, the ontology-based development environment 2 may generate 1002 a completion callback. The completion callback may be triggered when a source feature has been successfully executed, as indicated by either a triggering event or generation of a parameter. The ontology-based development environment 2 may generate 1004 a wait dependency for the destination feature dependent on the completion callback. Once the source feature has successfully completed, the source feature notifies 1006 the host that it has successfully completed. The host may then verify 1008 that each of the dependencies of the destination feature has been satisfied. In various embodiments, the destination feature may comprise one or more parameter bindings, one or more topic bindings, and/or one or more completion trigger bindings.

In one embodiment, after verifying 1008 that the dependencies of the destination feature have been satisfied, the host may trigger 1010 the completion callback trigger, causing the destination feature to execute.

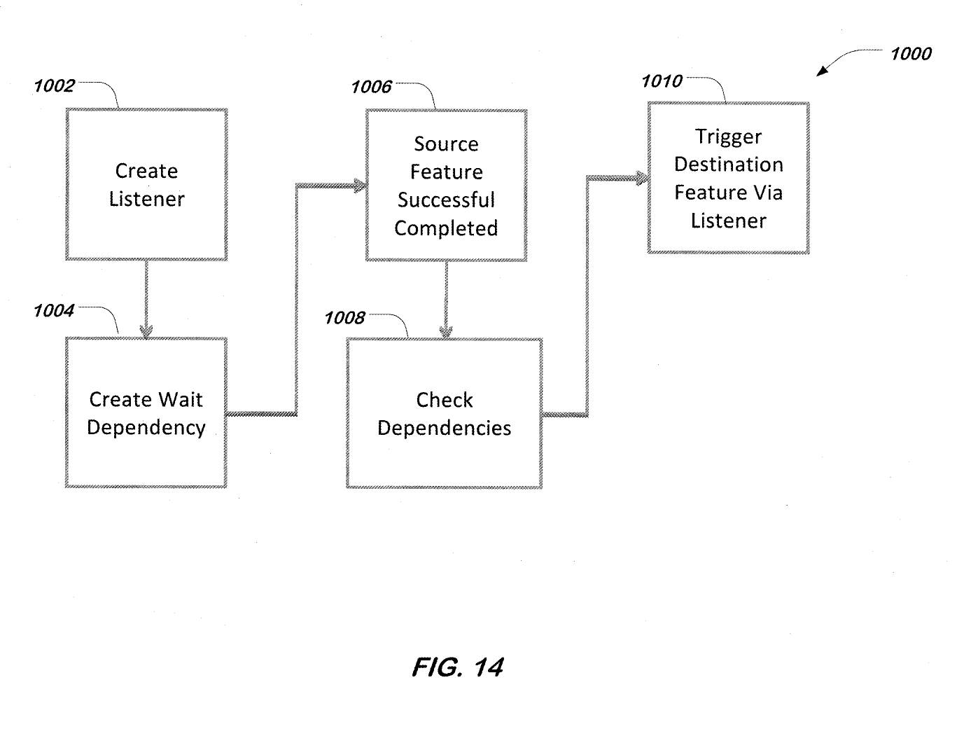

FIG. 15 is a schematic view of an illustrative electronic device 1100 capable of implementing the system and method of ontology-based user generation of apps. Electronic device 1100 may comprise a processor subsystem 1102, an input/output subsystem 1104, a memory subsystem 1106, a communications interface 1108, and a system bus 1110. In some embodiments, one or more than one of the electronic device 1100 components may be combined or omitted such as, for example, not including the communications interface 1108. In some embodiments, the electronic device 1100 may comprise other components not combined or comprised in those shown in FIG. 15. For example, the electronic device 1100 also may comprise a power subsystem. In other embodiments, the electronic device 1100 may comprise several instances of the components shown in FIG. 15. For example, the electronic device 1100 may comprise multiple memory subsystems 1106. For the sake of conciseness and clarity, and not limitation, one of each of the components is shown in FIG. 15.

The processor subsystem 1102 may comprise any processing circuitry operative to control the operations and performance of the electronic device 1100. In various aspects, the processor subsystem 1102 may be implemented as a general purpose processor, a chip multiprocessor (CMP), a dedicated processor, an embedded processor, a digital signal processor (DSP), a network processor, a media processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 102 also may be implemented by a controller, a microcontroller, an application specific integrated circuit (ASIC), a field programmable gate array (FPGA), a programmable logic device (PLD), and so forth.

In various aspects, the processor subsystem 1102 may be arranged to run an operating system (OS) and various mobile applications. Examples of an OS comprise, for example, operating systems generally known under the trade name of Apple OS, Microsoft Windows OS, Android OS, and any other proprietary or open source OS. Examples of mobile applications comprise, for example, a telephone application, a camera (e.g., digital camera, video camera) application, a browser application, a multimedia player application, a gaming application, a messaging application (e.g., email, short message, multimedia), a viewer application, and so forth.

In some embodiments, the electronic device 1100 may comprise a system bus 1110 that couples various system components including the processing subsystem 1102, the input/output subsystem 1104, and the memory subsystem 1106. The system bus 1110 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for mobile computing device applications.

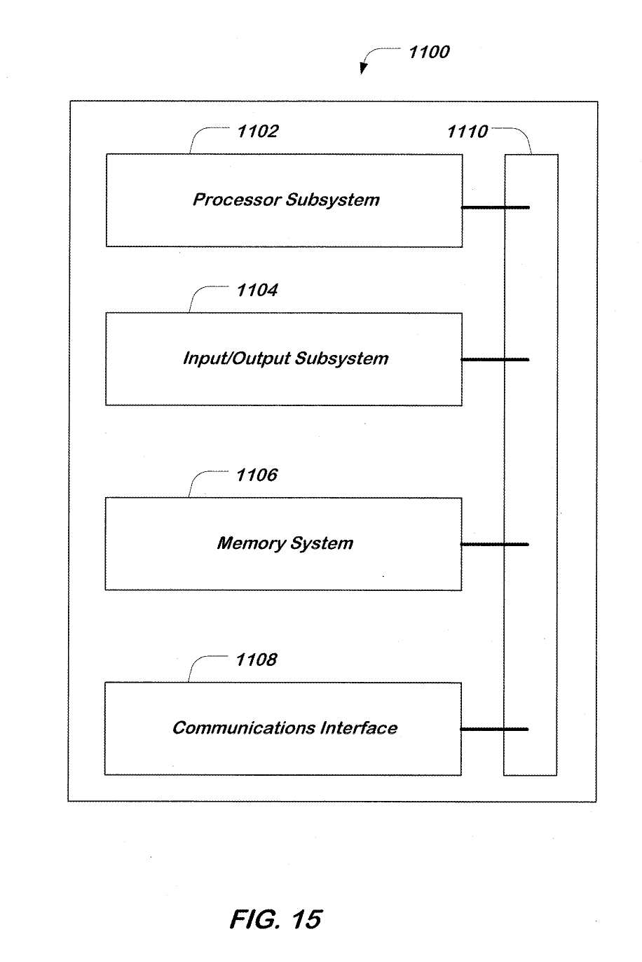

FIG. 16 shows one embodiment of the input/output subsystem 1104 of the electronic device 1100 shown in FIG. 15. The input/output subsystem 1104 may comprise any suitable mechanism or component to at least enable a user to provide input to the electronic device 1100 and the electronic device 1100 to provide output to the user. For example, the input/output subsystem 1104 may comprise any suitable input mechanism, including but not limited to, a button, keypad, keyboard, click wheel, touch screen, or motion sensor. In some embodiments, the input/output subsystem 1104 may comprise a capacitive sensing mechanism, or a multi-touch capacitive sensing mechanism. Descriptions of capacitive sensing mechanisms can be found in U.S. Patent Application Publication No. 2006/0026521, entitled “Gestures for Touch Sensitive Input Device” and U.S. Patent Publication No. 2006/0026535, entitled “Mode-Based Graphical User Interfaces for Touch Sensitive Input Device,” both of which are incorporated by reference herein in their entirety. It will be appreciated that any of the input mechanisms described herein may be implemented as physical mechanical components, virtual elements, and/or combinations thereof.

In some embodiments, the input/output subsystem 1104 may comprise specialized output circuitry associated with output devices such as, for example, an audio peripheral output device 1208. The audio peripheral output device 1208 may comprise an audio output including on or more speakers integrated into the electronic device. The speakers may be, for example, mono or stereo speakers. The audio peripheral output device 1208 also may comprise an audio component remotely coupled to audio peripheral output device 1208 such as, for example, a headset, headphones, and/or ear buds which may be coupled to the audio peripheral output device 1208 through the communications subsystem 1108.

In some embodiments, the input/output subsystem 1104 may comprise a visual peripheral output device 1202 for providing a display visible to the user. For example, the visual peripheral output device 1202 may comprise a screen such as, for example, a Liquid Crystal Display (LCD) screen, incorporated into the electronic device 1100. As another example, the visual peripheral output device 1202 may comprise a movable display or projecting system for providing a display of content on a surface remote from the electronic device 1100. In some embodiments, the visual peripheral output device 1202 can comprise a coder/decoder, also known as a Codec, to convert digital media data into analog signals. For example, the visual peripheral output device 1202 may comprise video Codecs, audio Codecs, or any other suitable type of Codec.

The visual peripheral output device 1202 also may comprise display drivers, circuitry for driving display drivers, or both. The visual peripheral output device 1202 may be operative to display content under the direction of the processor subsystem 1102. For example, the visual peripheral output device 1202 may be able to play media playback information, application screens for application implemented on the electronic device 1100, information regarding ongoing communications operations, information regarding incoming communications requests, or device operation screens, to name only a few.

In some embodiments, the input/output subsystem 1104 may comprise a motion sensor 1204. The motion sensor 1204 may comprise any suitable motion sensor operative to detect movements of electronic device 1100. For example, the motion sensor 1204 may be operative to detect acceleration or deceleration of the electronic device 1100 as manipulated by a user. In some embodiments, the motion sensor 1204 may comprise one or more three-axis acceleration motion sensors (e.g., an accelerometer) operative to detect linear acceleration in three directions (i.e., the x or left/right direction, the y or up/down direction, and the z or forward/backward direction). As another example, the motion sensor 1204 may comprise one or more two-axis acceleration motion sensors which may be operative to detect linear acceleration only along each of x or left/right and y or up/down directions (or any other pair of directions). In some embodiments, the motion sensor 1204 may comprise an electrostatic capacitance (capacitance-coupling) accelerometer that is based on silicon micro-machined MEMS (Micro Electro Mechanical Systems) technology, a piezoelectric type accelerometer, a piezoresistive type accelerometer, or any other suitable accelerometer.

In some embodiments, the motion sensor 1204 may be operative to directly detect rotation, rotational movement, angular displacement, tilt, position, orientation, motion along a non-linear (e.g., arcuate) path, or any other non-linear motions. For example, when the motion sensor 1204 is a linear motion sensor, additional processing may be used to indirectly detect some or all of the non-linear motions. For example, by comparing the linear output of the motion sensor 1204 with a gravity vector (i.e., a static acceleration), the motion sensor 1204 may be operative to calculate the tilt of the electronic device 1100 with respect to the y-axis. In some embodiments, the motion sensor 1204 may instead or in addition comprise one or more gyro-motion sensors or gyroscopes for detecting rotational movement. For example, the motion sensor 1204 may comprise a rotating or vibrating element.

In some embodiments, the motion sensor 1204 may comprise one or more controllers (not shown) coupled to the accelerometers or gyroscopes. The controllers may be used to calculate a moving vector of the electronic device 1100. The moving vector maybe determined according to one or more predetermined formulas based on the movement data (e.g., x, y, and z axis moving information) provided by the accelerometers or gyroscopes.

In some embodiments, the input/output subsystem 1104 may comprise a virtual input/output system 1206. The virtual input/output system 1206 is capable of providing input/output options by combining one or more input/output components to create a virtual input type. For example, the virtual input/output system 1206 may enable a user to input information through an on-screen keyboard which utilizes the touch screen and mimics the operation of a physical keyboard or using the motion sensor 1204 to control a pointer on the screen instead of utilizing the touch screen. As another example, the virtual input/output system 1206 may enable alternative methods of input and output to enable use of the device by persons having various disabilities. For example, the virtual input/output system 1206 may convert on-screen text to spoken words to enable reading-impaired persons to operate the device.

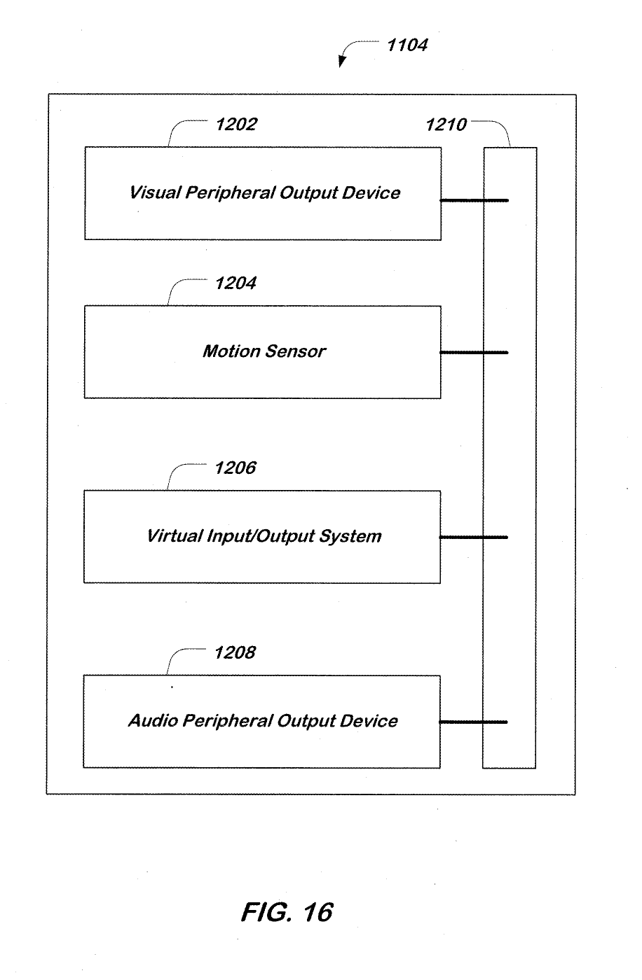

FIG. 17 shows one embodiment of the communication interface 1108. The communications interface 1108 may comprises any suitable hardware, software, or combination of hardware and software that is capable of coupling the electronic device 1100 to one or more networks and/or devices. The communications interface 1108 may be arranged to operate with any suitable technique for controlling information signals using a desired set of communications protocols, services or operating procedures. The communications interface 1108 may comprise the appropriate physical connectors to connect with a corresponding communications medium, whether wired or wireless.

Vehicles of communication comprise a network. In various aspects, the network may comprise local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers. In various implementations, the wired communication modules may communicate in accordance with a number of wired protocols. Examples of wired protocols may comprise Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 1108 may comprise one or more interfaces such as, for example, a wireless communications interface 1306, a wired communications interface 1304, a network interface, a transmit interface, a receive interface, a media interface, a system interface, a component interface, a switching interface, a chip interface, a controller, and so forth. When implemented by a wireless device or within wireless system, for example, the communications interface 1108 may comprise a wireless interface 1306 comprising one or more antennas 1310, transmitters, receivers, transceivers, amplifiers, filters, control logic, and so forth.

In various aspects, the communications interface 108 may provide voice and/or data communications functionality in accordance with different types of cellular radiotelephone systems. In various implementations, the described aspects may communicate over wireless shared media in accordance with a number of wireless protocols. Examples of wireless protocols may comprise various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may comprise various wireless wide area network (WWAN) protocols, such as GSM cellular radiotelephone system protocols with GPRS, CDMA cellular radiotelephone communication systems with 1xRTT, EDGE systems, EV-DO systems, EV-DV systems, HSDPA systems, and so forth. Further examples of wireless protocols may comprise wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Yet another example of wireless protocols may comprise near-field communication techniques and protocols, such as electro-magnetic induction (EMI) techniques. An example of EMI techniques may comprise passive or active radio-frequency identification (RFID) protocols and devices. Other suitable protocols may comprise Ultra Wide Band (UWB), Digital Office (DO), Digital Home, Trusted Platform Module (TPM), ZigBee, and so forth.

In various implementations, the described aspects may comprise part of a cellular communication system. Examples of cellular communication systems may comprise CDMA cellular radiotelephone communication systems, GSM cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, Narrowband Advanced Mobile Phone Service (NAMPS) cellular radiotelephone systems, third generation (3G) wireless standards systems such as WCDMA, CDMA-2000, UMTS cellular radiotelephone systems compliant with the Third-Generation Partnership Project (3GPP), fourth generation (4G) wireless standards, and so forth.

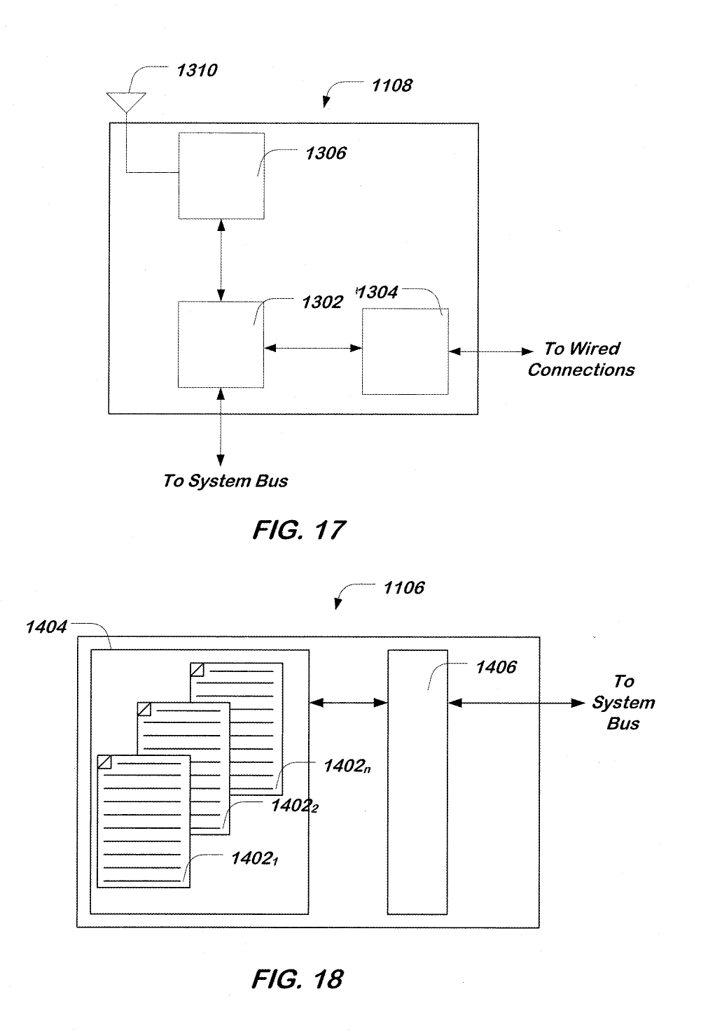

FIG. 18 shows one embodiment of the memory subsystem 1106. The memory subsystem 106 may comprise any machine-readable or computer-readable media capable of storing data, including both volatile/non-volatile memory and removable/non-removable memory. The memory subsystem 1106 may comprise at least one non-volatile memory unit 1402. The non-volatile memory unit 1402 is capable of storing one or more software programs 1404₁-1404ₙ. The software programs 1404₁-1404ₙ may contain, for example, applications, user data, device data, and/or configuration data, or combinations therefore, to name only a few. The software programs 1404₁-1404ₙ may contain instructions executable by the various components of the electronic device 1100.

In various aspects, the memory subsystem 1106 may comprise any machine-readable or computer-readable media capable of storing data, including both volatile/non-volatile memory and removable/non-removable memory. For example, memory may comprise read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In some embodiments, the memory subsystem 106 may contain a software program for implementing an ontology-based development environment 2 for user generation of apps using the capabilities of the mobile computing device 1100 and the motion sensor 1204, as discussed in connection with FIGS. 15-16. In one embodiment, the memory subsystem 1106 may contain an instruction set, in the form of a file 1404ₙ comprising the ontology-based development environment 2 for ontology-based user generation of apps. The instruction set may be stored in any acceptable form of machine readable instructions, including source code or various appropriate programming languages. Some examples of programming languages that may be used to store the instruction set comprise, but are not limited to: Java, C, C++, C#, Python, Objective-C, Visual Basic, or .NET programming. In some embodiments a compiler or interpreter is comprised to convert the instruction set into machine executable code for execution by the processing subsystem 1102.

Examples of handheld mobile devices suitable for implementing the system and method of ontology-based user generation of apps comprise, but are not limited to: the Apple iPhone™ and iPod™, RIM Blackberry® Curve™, Pearl™, Storm™, and Bold™; Hewlett Packard Veer; Palm® (now HP) Pixi™, Pre™; Google Nexus S™ Motorola DEFY™, Droid (generations 1-3), Droid X, Droid X2, Flipside™, Atrix™, and Citrus™; HTC Incredible™, Inspire™, Surround™, EVO™, G2™, HD7, Sensation™, Thunderbolt™ and Trophy™; LG Fathom™, Optimus T™, Phoenix™, Quantum™, Revolution™, Rumor Touch™, and Vortex™; Nokia Astound™; Samsung Captivate™, Continuum™, Dart™, Droid Charge™, Exhibit™, Epic™, Fascinate™, Focus™, Galaxy S™, Gravity™, Infuse™, Replenish™, Seek™, and Vibrant™; Pantech Crossover; T-Mobile® G2™, Comet™, myTouch™; Sidekick®; Sanyo Zio™; Sony Ericsson Xperia™ Play.

Examples of tablet computing devices suitable for implementing the system and method of ontology-based user generation of apps comprise, but are not limited to: Acer Iconia Tab A500, the Apple iPad™ (1 and 2), Asus Eee Pad Transformer, Asus Eee Slate, Coby Kyros, Dell Streak, Hewlett Packard TouchPad, Motorola XOOM, Samsung Galaxy Tab, Archos 101 internet tablet, Archos 9 PC tablet, Blackberry PlayBook, Hewlett Packard Slate, Notion ink Adam, Toshiba Thrive, and the Viewsonic Viewpad.

The functions of the various functional elements, logical blocks, modules, and circuits elements described in connection with the embodiments disclosed herein may be implemented in the general context of computer executable instructions, such as software, control modules, logic, and/or logic modules executed by the processing unit. Generally, software, control modules, logic, and/or logic modules comprise any software element arranged to perform particular operations. Software, control modules, logic, and/or logic modules can comprise routines, programs, objects, components, data structures and the like that perform particular tasks or implement particular abstract data types. An implementation of the software, control modules, logic, and/or logic modules and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, control modules, logic, and/or logic modules may be located in both local and remote computer storage media including memory storage devices.

Additionally, it is to be appreciated that the embodiments described herein illustrate example implementations, and that the functional elements, logical blocks, modules, and circuits elements may be implemented in various other ways which are consistent with the described embodiments. Furthermore, the operations performed by such functional elements, logical blocks, modules, and circuits elements may be combined and/or separated for a given implementation and may be performed by a greater number or fewer number of components or modules. As will be apparent to those of skill in the art upon reading the present disclosure, each of the individual embodiments described and illustrated herein has discrete components and features which may be readily separated from or combined with the features of any of the other several aspects without departing from the scope of the present disclosure. Any recited method can be carried out in the order of events recited or in any other order which is logically possible.

It is worthy to note that any reference to “one embodiment” or “an embodiment” means that a particular feature, structure, or characteristic described in connection with the embodiment is comprised in at least one embodiment. The appearances of the phrase “in one embodiment” or “in one aspect” in the specification are not necessarily all referring to the same embodiment.

Unless specifically stated otherwise, it may be appreciated that terms such as “processing,” “computing,” “calculating,” “determining,” or the like, refer to the action and/or processes of a computer or computing system, or similar electronic computing device, such as a general purpose processor, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, application program interface (API), exchanging messages, and so forth.

It will be appreciated that those skilled in the art will be able to devise various arrangements which, although not explicitly described or shown herein, embody the principles of the present disclosure and are comprised within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, aspects, and embodiments as well as specific examples thereof, are intended to encompass both structural and functional equivalents thereof. Additionally, it is intended that such equivalents comprise both currently known equivalents and equivalents developed in the future, i.e., any elements developed that perform the same function, regardless of structure. The scope of the present disclosure, therefore, is not intended to be limited to the exemplary aspects and aspects shown and described herein. Rather, the scope of present disclosure is embodied by the appended claims.

The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as when it was individually recited herein. All methods described herein can be performed in any suitable order unless otherwise indicated herein or otherwise clearly contradicted by context. The use of any and all examples, or exemplary language (e.g., “such as,” “in the case,” “by way of example”) provided herein is intended merely to better illuminate the disclosed embodiments and does not pose a limitation on the scope otherwise claimed. No language in the specification should be construed as indicating any non-claimed element essential to the practice of the claimed subject matter. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or embodiments disclosed herein are not to be construed as limitations. Each group member may be referred to and claimed individually or in any combination with other members of the group or other elements found herein. It is anticipated that one or more members of a group may be comprised in, or deleted from, a group for reasons of convenience and/or patentability.

While certain features of the embodiments have been illustrated as described above, many modifications, substitutions, changes and equivalents will now occur to those skilled in the art. It is therefore to be understood that the appended claims are intended to cover all such modifications and changes as fall within the scope of the disclosed embodiments.

Various aspects of the subject matter described herein are set out in the following numbered clauses:

1. A computer-implemented method for ontology-based application construction, the method comprising: generating, by a processor, a first component comprising a first ontology; matching, by the processor, a first parameter of the first component with at least one second component comprising a second ontology; and linking, by the processor, the first parameter of the first component with a second parameter of the second component.

2. The computer-implemented method of clause 1, comprising generating the first component comprising a first ontology configured to identify at least one feature of the first component.

3. The computer-implemented method of clause 2, comprising matching, by the processor, the first parameter of the first component with the second component based on at least one matching term in the first ontology and the second ontology.

4. The computer-implemented method of clause 3, comprising linking, by the processor, the first parameter and the second parameter, wherein the first parameter comprises an input of the first component and the second parameter comprises an output of the second component.

5. The computer-implemented method of clause 3, comprising linking, by the processor, the first parameter and the second parameter, wherein the first parameter comprises an output of the first component and the second parameter comprises an input of the second component.

6. The computer-implemented method of clause 3, comprising storing, by the processor, the first component in a component store.

7. The computer-implemented method of clause 6, comprising retrieving, by the processor, the second component from a component store, wherein the component store stores at least one component and associated ontologies.

8. The computer-implemented method of clause 5, comprising: identifying, by the processor, at least one ontological term of the first component; parsing, by the processor, the at least one ontological term to identify a stem of the at least one ontological term; updating, by the processor, the ontological terms of the first component to include the stem of the at least one ontological term.

9. The computer-implemented method of clause 3, comprising generating, by the processor, the first component comprising a mobile component configured to be executed by a mobile computing platform.

10. A computer-implemented method for generating an application component comprising: generating, by a processor, a first component comprising at least one function and at least one parameter; identifying, by the processor, at least one ontological term associated with the first component; and generating, by the processor, an ontology for the first component, wherein the ontology identifies the at least one function and the at least one parameter of the first component.

11. The computer-implemented method of clause 10, comprising: parsing, by the processor, at least one term of the ontology to identify a stem of the at least one term; and updating, by the processor, the ontology for the first component to include the stem of the at least one term.

12. The computer-implemented method of clause 10, comprising storing, by the processor, the first component and the ontology in a component store.

13. The computer-implemented method of clause 12, comprising storing, by the processor, the first component and the ontology in a local component store.

14. The computer-implemented method of clause 12, comprising storing, by the processor, the first component and the ontology in a remote component store.

15. The computer-implemented method of clause 10, comprising generating the ontology comprising at least one term selected from the group consisting of: a platform tag, a contributor tag, an object-type tag, a feature tag, a global object tag, and a parameter tag.

16. A computing device comprising: a processor; and a non-transitory computer-readable medium coupled to the processor, the non-transitory computer-readable medium configured to store a computer program instructions that when executed by the processor are operable to cause the processor to: construct a first component comprising a first ontology, wherein the first ontology is configured to describe at least one feature of the first component; match a first parameter of the first component with at least one second component comprising a second ontology configured to describe on or more features of the second component; and link the first parameter of the first component with a second parameter of the second component.

17. The computing device of clause 16, wherein the instructions cause the processor to match the first parameter of the first component with the second component based on at least one matching term of the first ontology and the second ontology.

18. The computing device of clause 17, wherein the instructions cause the processor to store the first component in a component store.

19. The computing device of clause 18, wherein the instructions cause the processor to retrieve the second component from the component store.

20. The computing device of clause 17, wherein first component comprises a mobile component configured to be executed by a mobile computing platform.

What is claimed is:

1. A computer-implemented method for ontology-based application construction, the method comprising:
generating, by a processor, a first component comprising a first ontology;
matching, by the processor, a first parameter of the first component with at least one second component comprising a second ontology; and
linking, by the processor, the first parameter of the first component with a second parameter of the second component.

2. The computer-implemented method of claim 1, comprising generating the first component comprising a first ontology configured to identify at least one feature of the first component.

3. The computer-implemented method of claim 2, comprising matching, by the processor, the first parameter of the first component with the second component based on at least one matching term in the first ontology and the second ontology.

4. The computer-implemented method of claim 3, comprising linking, by the processor, the first parameter and the second parameter, wherein the first parameter comprises an input of the first component and the second parameter comprises an output of the second component.

5. The computer-implemented method of claim 3, comprising linking, by the processor, the first parameter and the second parameter, wherein the first parameter comprises an output of the first component and the second parameter comprises an input of the second component.

6. The computer-implemented method of claim 3, comprising storing, by the processor, the first component in a component store.

7. The computer-implemented method of claim 6, comprising retrieving, by the processor, the second component from a component store, wherein the component store stores at least one component and associated ontologies.

8. The computer-implemented method of claim 5, comprising:
identifying, by the processor, at least one ontological term of the first component;
parsing, by the processor, the at least one ontological term to identify a stem of the at least one ontological term;
updating, by the processor, the ontological terms of the first component to include the stem of the at least one ontological term.

9. The computer-implemented method of claim 3, comprising generating, by the processor, the first component comprising a mobile component configured to be executed by a mobile computing platform.

10. A computer-implemented method for generating an application component comprising:
generating, by a processor, a first component comprising at least one function and at least one parameter;
identifying, by the processor, at least one ontological term associated with the first component; and
generating, by the processor, an ontology for the first component, wherein the ontology identifies the at least one function and the at least one parameter of the first component.

11. The computer-implemented method of claim 10, comprising:
parsing, by the processor, at least one term of the ontology to identify a stem of the at least one term; and
updating, by the processor, the ontology for the first component to include the stem of the at least one term.

12. The computer-implemented method of claim 10, comprising storing, by the processor, the first component and the ontology in a component store.

13. The computer-implemented method of claim 12, comprising storing, by the processor, the first component and the ontology in a local component store.

14. The computer-implemented method of claim 12, comprising storing, by the processor, the first component and the ontology in a remote component store.

15. The computer-implemented method of claim 10, comprising generating the ontology comprising at least one term selected from the group consisting of: a platform tag, a contributor tag, an object-type tag, a feature tag, a global object tag, and a parameter tag.

16. A computing device comprising:
a processor; and
a non-transitory computer-readable medium coupled to the processor, the non-transitory computer-readable medium configured to store computer program instructions that when executed by the processor are operable to cause the processor to:
construct a first component comprising a first ontology, wherein the first ontology is configured to describe at least one feature of the first component;
match a first parameter of the first component with at least one second component comprising a second ontology configured to describe on or more features of the second component; and
link the first parameter of the first component with a second parameter of the second component.

17. The computing device of claim 16, wherein the instructions cause the processor to match the first parameter of the first component with the second component based on at least one matching term of the first ontology and the second ontology.

18. The computing device of claim 17, wherein the instructions cause the processor to store the first component in a component store.

19. The computing device of claim 18, wherein the instructions cause the processor to retrieve the second component from the component store.

20. The computing device of claim 17, wherein first component comprises a mobile component configured to be executed by a mobile computing platform.
